(19) United States
(12) Patent Application Publication
(10) Pub. No.: US 2019/0037152 A1
(43) Pub. Date: Jan. 31, 2019

(54) IMAGING DEVICE

(71) Applicant: NIPPON AVIONICS CO., LTD., Tokyo (JP)

(72) Inventors: Yasushi UDA, Tokyo (JP); Shoichi KIMURA, Tokyo (JP); Eijiro TANJI, Tokyo (JP); Kenji FUE, Tokyo (JP)

(73) Assignee: NIPPON AVIONICS CO., LTD., Tokyo (JP)

(21) Appl. No.: 15/892,545

(22) Filed: Feb. 9, 2018

(30) Foreign Application Priority Data
Jul. 31, 2017 (JP) 2017-147568

(51) Int. Cl. H04N 5/33; H04N 5/232

(52) U.S. Cl. CPC H04N 5/33; H04N 5/23296

(57) ABSTRACT

An imaging device includes an imaging terminal device having an imaging member, a controller having an operation section that operates the imaging terminal device, and a coupling portion that couples the imaging terminal device and the controller to each other in a manner in which the imaging terminal device and the controller can be detached from each other and rotated relative to each other. In the imaging device, the coupling portion is configured by an imaging-side coupling member provided in the imaging terminal device and a controller-side coupling member provided in the controller, the controller-side coupling member being fitted into the imaging-side coupling member, and at least one of the imaging-side coupling member and the controller-side coupling member is provided at a plurality of places.

### CROSS REFERENCES TO RELATED APPLICATIONS

The present invention contains subject matter related to Japanese Patent Application JP 2017-147568 filed in the Japanese Patent Office on Jul. 31, 2017, the entire contents of which being incorporated herein by reference.

### BACKGROUND OF THE INVENTION

### Field of the Invention

The present invention relates to an imaging device, particularly to an imaging device having a swivel mechanism.

### Description of the Related Art

As one type of an imaging device capable of easily performing photographing corresponding to various styles, there is known an imaging device having a swivel mechanism formed by coupling a first casing and a second casing to each other in a manner in which the first casing and the second casing can be rotated relative to each other, wherein the first casing has an imaging optical system and the second casing has a display. Further, as such an imaging device, a configuration in which the first casing and the second casing can be mutually attached and detached is disclosed. Such imaging device may also be used in a state where the first casing and the second casing are separated from each other, instead of being limited to be used in a state where the first casing and the second casing are coupled to each other (see Japanese Unexamined Patent Application Publication No. 2015-177334).

### SUMMARY OF THE INVENTION

However, in the imaging device having the aforesaid configuration, when performing photographing in a state where the two casings are coupled to each other, there exists a case where operation section(s) provided in either of the two casings is difficult to be operated by the photographer and a case where the display of the second casing is difficult to be viewed by the photographer, depending on the angle between the first casing and the second casing.

In view of the aforesaid problems, it is an object of the present invention to provide an imaging device which can further improve operability while having a swivel mechanism.

To achieve the aforesaid object, an imaging device according to an aspect of the present invention includes: an imaging terminal device having an imaging member; a controller having an operation section that operates the imaging terminal device; and a coupling portion that couples the imaging terminal device and the controller to each other in a manner in which the imaging terminal device and the controller can be detached from each other and rotated relative to each other, wherein the coupling portion is configured by an imaging-side coupling member provided in the imaging terminal device and a controller-side coupling member provided in the controller, the controller-side coupling member being adapted to be fitted to the imaging-side coupling member, and wherein at least one of the imaging-side coupling member and the controller-side coupling member is provided at a plurality of places.

With the imaging device having the aforesaid configuration, it is possible to further improve operability while having a swivel mechanism formed by coupling the imaging terminal device and the controller in a manner in which the imaging terminal device and the controller can be rotated relative to each other.

### BRIEF DESCRIPTION OF THE DRAWINGS

FIG. 1 is a perspective view showing overall configuration of an imaging device according to an embodiment of the present invention;

FIG. 2 is a perspective view showing an imaging terminal device according to the aforesaid embodiment when viewed from one direction;

FIG. 3 is a perspective view showing the imaging terminal device according to the aforesaid embodiment when viewed from another direction;

FIG. 4 is a functional block diagram of the imaging terminal device according to the aforesaid embodiment;

FIG. 5 is a perspective view showing a controller according to the aforesaid embodiment when viewed from the side of a display surface thereof;

FIG. 6 is a perspective view showing the controller according to the aforesaid embodiment when viewed from the side of a rear surface thereof;

FIG. 7 is a functional block diagram of the controller according to the aforesaid embodiment;

FIG. 8A and FIG. 8B are views showing a first example of the use configuration of the imaging device according to the aforesaid embodiment;

FIG. 9 is a view showing a second example of the use configuration of the imaging device according to the aforesaid embodiment; and

FIG. 10 is a view showing a third example of the use configuration of the imaging device according to the aforesaid embodiment.

### DESCRIPTION OF THE PREFERRED EMBODIMENT(S)

An embodiment of an imaging device according to the present invention will be described below with reference to the attached drawings. Note that the description hereinafter is based on an embodiment in which the present invention is applied to an infrared thermography device having an infrared camera. However, the present invention is not limited to such embodiment, but may be widely applied to an imaging device having a configuration in which an imaging terminal device and a controller for operating the imaging terminal device are coupled to each other as separated devices.

### <<Overall Configuration of Imaging Device>>

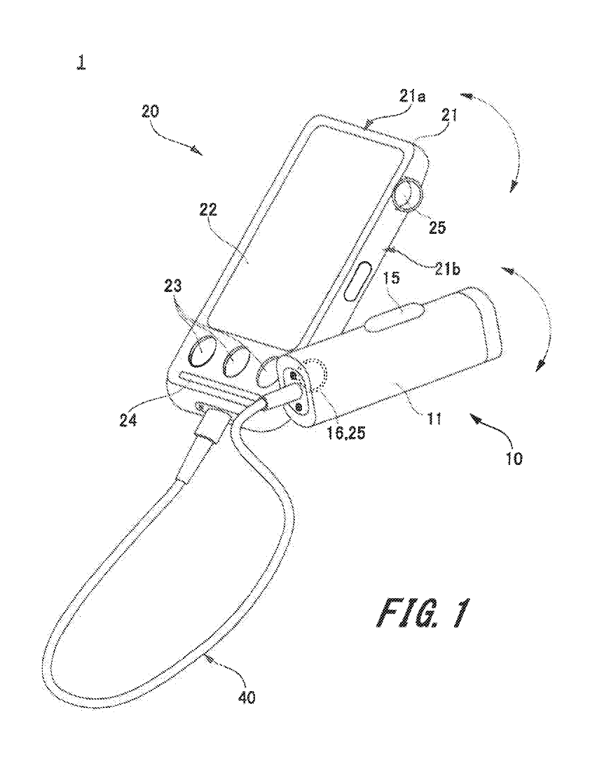

FIG. 1 is a perspective view showing overall configuration of an imaging device 1 according to an embodiment of the present invention. As shown in FIG. 1, the imaging device 1 includes an imaging terminal device 10, a controller 20, and a connection cable 40. Among these components, the imaging terminal device 10 has an imaging member, and is adapted to convert photographed images into an electric signal; the controller 20 has a display, and is adapted to operate the imaging terminal device 10; and the connection cable 40 is adapted to connect the imaging terminal device 10 and the controller 20 to each other.

The imaging terminal device 10 and the controller 20 are used in a state where the both components are detachably coupled to each other and where the coupling portion of the both components is provided with a swivel mechanism so that the both components can rotate relatively to each other. Particularly, at least one of the imaging terminal device 10 and the controller 20 is provided with a plurality of places to which the other one is to be detachably coupled. Here, the embodiment of the present invention is described based on an example in which the imaging terminal device 10 is to be detachably coupled to two places of the controller 20. The details of the configuration of the imaging terminal device 10, the configuration of the controller 20 and the configuration of the connection cable 40 will be described below in this order, and thereafter use examples of the imaging device 1 will be described.

### <<Imaging Terminal Device 10>>

### <Appearance Configuration of Imaging Terminal Device 10>

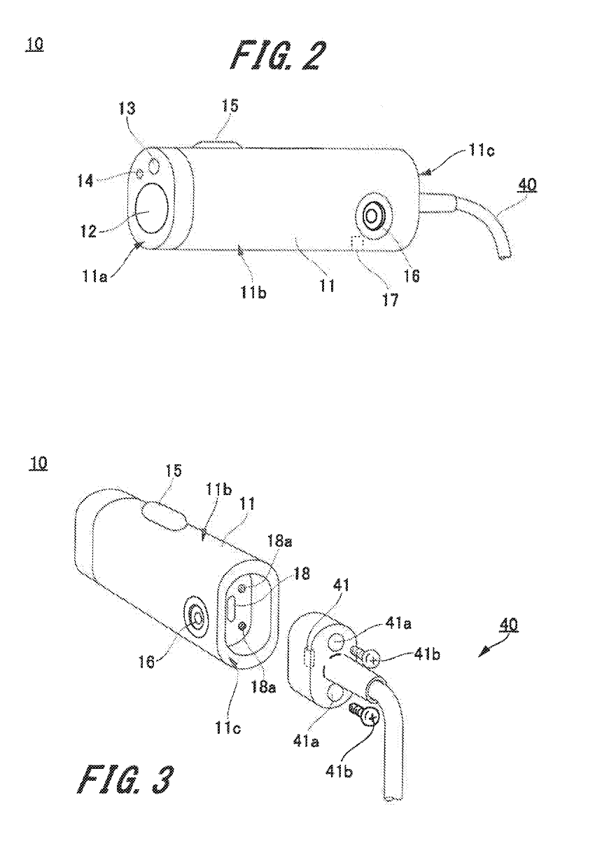

FIG. 2 is a perspective view showing the imaging terminal device 10 according to the embodiment of the present invention when viewed from one direction, and FIG. 3 is a perspective view showing the imaging terminal device 10 according to the embodiment when viewed from another direction. As shown in FIGS. 1 to 3, as one example, the imaging terminal device 10 includes an imaging casing 11 having a substantially cylindrical shape with two closed bottoms.

One bottom of the imaging casing 11 is an imaging surface 11a, which is adapted to face a subject-to-be-imaged. A side peripheral surface 11b of the imaging casing 11 is a surface to be gripped by the photographer. The other bottom of the imaging casing 11 is a connection surface 11c, to which the connection cable 40 is to be connected. The imaging surface 11a, the side peripheral surface 11b, and the connection surface 11c are provided with respective elements constituting the imaging terminal device 10 as below.

The imaging surface 11a is provided with imaging members such as the infrared camera 12, the visible camera 13 and the lighting device 14. The side peripheral surface 11b is provided with an operation section 15, an imaging-side coupling member 16, and a tripod socket 17. The connection surface 11c is provided with a connection terminal 18 to which the connection cable 40 is to be connected. The details of the configuration and arrangement state of the aforesaid elements will be described below.

### [Infrared Camera 12]

The infrared camera 12 includes a lens, an infrared imaging element, a buffer amplifier, and an A/D converter. The infrared camera 12 is housed in the imaging casing 11 in a state where a light-receiving surface thereof, on which the lens is arranged, faces the imaging surface 11a.

### [Visible Camera 13]

The visible camera 13 includes a lens, a visible light imaging element, a buffer amplifier, and an A/D converter. The visible camera 13 is used to confirm a subject-to-be-imaged to be imaged by the infrared camera 12, and is housed in the imaging casing 11 in a state where a light-receiving surface thereof, on which the lens is arranged, faces the imaging surface 11a.

### [Lighting Device 14]

The lighting device 14 is adapted to emit illumination light to the subject-to-be-imaged while the subject-to-be-imaged is being imaged by the infrared camera 12 and the visible camera 13, and is housed in the imaging casing 11 in a state where a light-emitting surface thereof faces the imaging surface 11a.

### [Operation Section 15]

The operation section 15 is a button to be operated for the infrared camera 12 and the visible camera 13 to take an image. The operation section 15 is, for example, an image recording button for taking a one-shot image, for example. A one-shot image is taken by pressing the operation section 15. Such operation section 15 is arranged on the side peripheral surface 11b of the imaging casing 11, at a position near the imaging surface 11a. Incidentally, the portion where the operation section 15 is arranged on the side peripheral surface 11b of the imaging casing 11 may be formed into a recessed shape, so that the operation section 15 can be prevented from being erroneously operated.

### [Imaging-Side Coupling Member 16]

The imaging-side coupling member 16 is a portion for coupling the imaging terminal device 10 and the controller 20 to each other in a manner in which the imaging terminal device 10 and the controller 20 can be detached from each other and rotated relative to each other. Such imaging-side coupling member 16 is arranged on the side peripheral surface 11b of the imaging casing 11, at a position deviated from the portion where the operation section 15 is arranged in the circumferential direction of the side peripheral surface 11b. Further, the imaging-side coupling member 16 is arranged at a position such that, in a state where the imaging terminal device 10 and the controller 20 are coupled to each other, the operation section 15 can be operated without being obstructed. As one example, the imaging-side coupling member 16 is arranged on the side peripheral surface 11b of the imaging casing 11, at a position near the connection surface 11c.

Incidentally, the configuration of the imaging-side coupling member 16 is not particularly limited as long as it is possible to couple the imaging terminal device 10 and the controller 20 to each other in a manner in which the imaging terminal device 10 and the controller 20 can be detached from each other and rotated relative to each other, by fitting the imaging-side coupling member 16 into a controller-side coupling member of the controller 20.

### [Tripod Socket 17]

The tripod socket 17 is a screw hole portion for fixing the imaging terminal device 10 to a tripod. The tripod socket is arranged on the side peripheral surface 11b of the imaging casing 11 at a point that is opposite to the portion where the operation section 15 is disposed in circumferential direction, and that is on a surface forming a 90-degree angle with respect the surface where the imaging-side coupling member 16 is arranged.

### [Connection Terminal 18]

Referring back to FIG. 3, the connection terminal 18 is a portion to which the connection cable 40 is to be connected, and is arranged on the side of the connection surface 11c. The connection terminal 18 is, for example, a USB port (which may be a micro USB port). Further, the imaging terminal device 10 may also be provided with two screw holes 18a, on the connection surface 11c of the imaging casing 11 at two positions with the connection terminal 18 interposed therebetween, for fixing the connection cable 40 to the imaging terminal device 10.

### <Functional Configuration of Imaging Terminal Device 10>

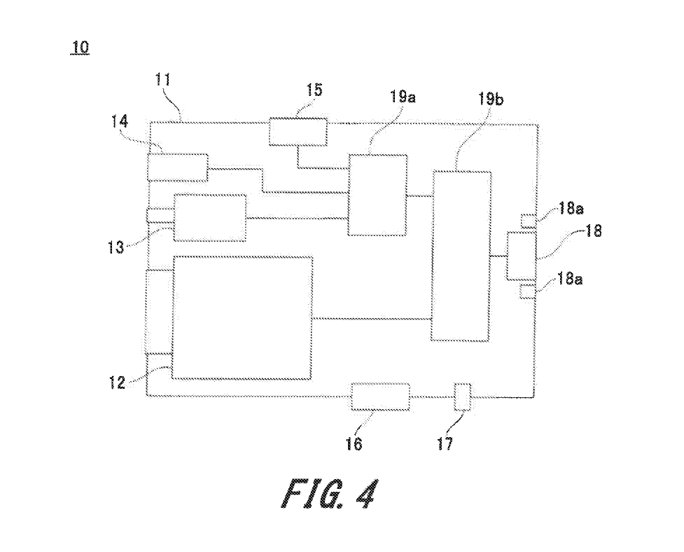

FIG. 4 is a functional block diagram of the imaging terminal device 10 according to the embodiment of the present invention. As shown in FIG. 4, in addition to the aforesaid elements, the imaging terminal device 10 also includes a bridge circuit 19a and a line concentrating circuit 19b. As circles mounted on an IC chip, the bridge circuit 19a and the line concentrating circuit 19b are housed in the imaging casing 11, and have the following configurations.

[Bridge Circuit 19a]

The bridge circuit 19a is a USB bridge circuit, for example, and is connected to the visible camera 13, the lighting device 14, the operation section 15 and the line concentrating circuit 19b to mutually connect these elements. The bridge circuit 19a converts an imaging signal obtained from the visible camera 13 and an input signal obtained from the operation section 15 into a USB interface signal, and sends the USB interface signal to the line concentrating circuit 19b. Further, the bridge circuit 19a converts a USB interface signal received through the line concentrating circuit 19b, and outputs the converted signal as a control signal for controlling the visible camera 13 and the lighting device 14.

[Line Concentrating Circuit 19b]

The line concentrating circuit 19b is a USB hub, and is connected to the bridge circuit 19a, the infrared camera 12 and the connection terminal 18. The line concentrating circuit 19b is adapted to send the imaging signal of the visible camera 13, the input signal obtained from the operation section 15, and an imaging signal obtained from the infrared camera 12 to the connection terminal 18, wherein the imaging signal of the visible camera 13 and the input signal obtained from the operation section 15 are transmitted from the bridge circuit 19a. Further, the line concentrating circuit 19b sends a signal inputted from the controller 20 through the connection terminal 18 to both the bridge circuit 19a and the infrared camera 12. Incidentally, in the present configuration, the infrared camera 12, the visible camera 13, and the lighting device 14 are operated by a signal from the controller 20 (which is to be described next) only. In other words, the signal from the operation section 15 is sent to the controller 20 through the bridge circuit 19a and the line concentrating circuit 19b, and the infrared camera 12, the visible camera 13 and the lighting device 14 are controlled from the controller 20.

### <<Controller 20>>

### <Appearance Configuration of Controller 20>

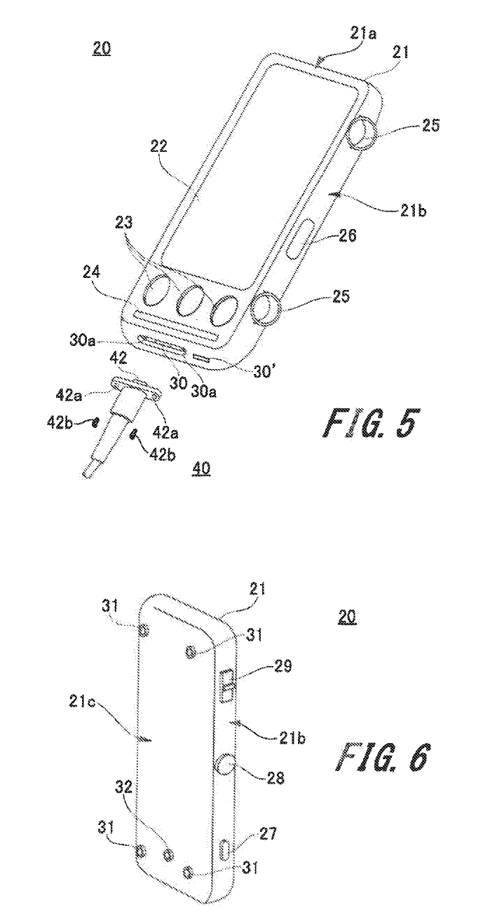

FIG. 5 is a perspective view showing the controller 20 according to the embodiment of the present invention when viewed from the side of a display surface thereof; and FIG. 6 is a perspective view showing the controller according to the embodiment when viewed from the side of a rear surface thereof. As shown in FIG. 1, FIG. 5 and FIG. 6, as one example, the controller 20 includes a flat box shaped operation casing 21. The flat box shaped operation casing 21 includes a display surface 21a (which is the main surface of the operation casing 21), a side peripheral surface 21b, and a rear surface 21c; wherein the rear surface 21c is opposite to the display surface 21a. The display surface 21a, the side peripheral surface 21b, and the rear surface 21c are provided with respective elements constituting the controller 20 as below.

The display surface 21a is provided with a display panel 22, function keys 23 and a speaker 24. The side peripheral surface 21b is provided with two controller-side coupling members 25, a recording medium inserting portion 26, a power button 27, an imaging operating section 28, a display operating section 29 and a connection terminal 30. The rear surface 21c is provided with four tap holes 31, and a tripod socket 32. The details of the configuration and arrangement state of the aforesaid elements will be described below.

### [Display Panel 22]

The display panel 22 is a flat panel display, and is housed in the operation casing 21 in a state where the display panel 22 constitutes a part of the display surface 21a of the operation casing 21. The display panel 22 is provided with a touch-screen, as an input means, on the front face of the display surface 21a, and may also serve as an operation section for operating the imaging terminal device 10.

### [Function Keys 23 and Speaker 24]

The function keys 23 are an operation portion to which switching functions for switching display on the display panel are assigned. The speaker 24 is a functional portion adapted to sound various types of alarms. The function keys 23 and the speaker 24 are arranged around the display panel 22 of the display surface 21a.

### [Controller-Side Coupling Members 25]

The controller-side coupling members 25 are each a portion for coupling the imaging terminal device 10 and the controller 20 to each other in a manner in which the imaging terminal device 10 and the controller 20 can be detached from each other and rotated relative to each other. Each controller-side coupling member 25 configures a coupling portion with the aforesaid imaging-side coupling member 16. The coupling portion configured by each of the controller-side coupling members 25 and the imaging-side coupling member 16 couples the imaging terminal device 10 and the controller 20 to each other on the side peripheral surface 21b substantially perpendicular to the display surface 21a of the display panel 22. The coupling portion couples the imaging terminal device 10 and the controller 20 to each other in a manner in which the controller 20 and the imaging terminal device 10 can be rotated relative to each other in parallel with a surface substantially perpendicular to the display surface 21a of the controller 20. With such a configuration, the controller 20 and the imaging terminal device 10 can be rotated relative to each other in a manner in which the upper portion of the display surface 21a will not be hidden by the imaging terminal device 10.

The two controller-side coupling members 25 for constituting the aforesaid coupling portion are provided at two places on the side peripheral surface 21b of the operation casing 21. It is preferred that, in the case where the display surface 21a has a rectangular shape, the two places where the controller-side coupling members 25 are provided are positioned separated from each other on a long side of the display surface 21a, for example. Further, it is preferred that controller-side coupling members 25 are each provided at a position so that, in the state where the imaging terminal device 10 and the controller 20 are coupled to each other, the operation section 15 of the imaging terminal device 10 and the display surface 21a of the controller 20 can face the same direction (the upward direction).

Incidentally, the configuration of the controller-side coupling members 25 is not particularly limited as long as it is possible to couple the imaging terminal device 10 and the controller 20 to each other in a manner in which the imaging terminal device 10 and the controller 20 can be detached from each other and rotated relative to each other, by fitting each of the controller-side coupling members 25 to the imaging-side coupling member 16 of the imaging terminal device 10.

### [Recording Medium Inserting Portion 26]

The recording medium inserting portion 26 is an inserting portion into which a recording medium such as a micro SD card is to be inserted. The recording medium inserting portion 26 may be arranged on the side peripheral surface 21b on a surface that faces the same direction as the controller-side coupling member 25 faces.

### [Power Button 27, Imaging Operating Section 28 and Display Operating Section 29]

The power button 27 is an operation section for turning on/off the controller 20. The imaging operating section 28 is a button for causing the infrared camera 12 and the visible camera 13 of the imaging terminal device 10 to take images; and the imaging operating section 28 may be, for example, an image recording button. The input signal of the imaging operating section 28, together with other control signals, is transmitted to the imaging terminal device 10 through the connection cable 40 (which will be described later). The display operating section 29 is a button for increasing/decreasing setting values displayed on the display panel 22 in various situations. For example, when converting an infrared camera image into a pseudo-colored image, the display operating section 29 is used for setting the range of display temperature.

The power button 27, the imaging operating section 28 and the display operating section 29 are arranged on the side peripheral surface 21b of the operation casing 21 at positions such that these parts can be operated without being obstructed in a state where the imaging terminal device 10 and the controller 20 are coupled to each other. As one example, the power button 27, the imaging operating section 28 and the display operating section 29 are arranged on the side peripheral surface 21b, on a side opposite to the controller-side coupling members 25.

### [Connection Terminal 30]

The connection terminal 30 is a portion to which the connection cable 40 is to be connected, and is provided on the side peripheral surface 21b of the operation casing 21. The connection terminal 30 is, for example, a USB port (which may also be a micro USB port). Further, it is preferred that the connection terminal 30 is provided at a position so that, in the state where the imaging terminal device 10 and the controller 20 are coupled to each other and where the operation section 15 of the imaging terminal device 10 and the display surface 21a of the controller 20 face the same direction (the upward direction), the connection terminal 30 faces the same direction as that of the connection surface 11c of the imaging terminal device 10. Further, the controller 20 may also be provided with two screw holes 30a, on the side peripheral surface 21b at two positions with the connection terminal 30 interposed therebetween, for fixing the connection cable 40 to the controller 20.

Further, the controller 20 may also be provided with another connection terminal 30′. The connection terminal 30′ may have the same configuration as that of the connection terminal 30. These two connection terminals 30, 30′ may be arranged on the side peripheral surface 21b in a state where the connection of the connection cable 40 or the like to either one of the two connection terminals 30, 30′ is not obstructed.

### [Tap Hole 31]

The tap holes 31 are used to fix the controller 20 to any wall surface or column, and are arranged at four corners of the rear surface 21c of the controller 20.

### [Tripod Socket 32]

The tripod socket 32 is a screw hole portion for fixing the controller 20 to a tripod. The position of the tripod socket 32 on the rear surface 21c of the controller 20 is not particularly limited; however, it is preferred that the tripod socket 32 is arranged at a position so that, in a state where the controller 20 coupled to the imaging terminal device 10 is fixed to a tripod, the rotation in the coupling portion between the imaging terminal device 10 and the controller 20 is not restricted, for example. As one example, the tripod socket 32 is arranged on the rear surface 21c of the controller 20, at a position near the connection terminal 30.

### <Functional Configuration of Controller 20>

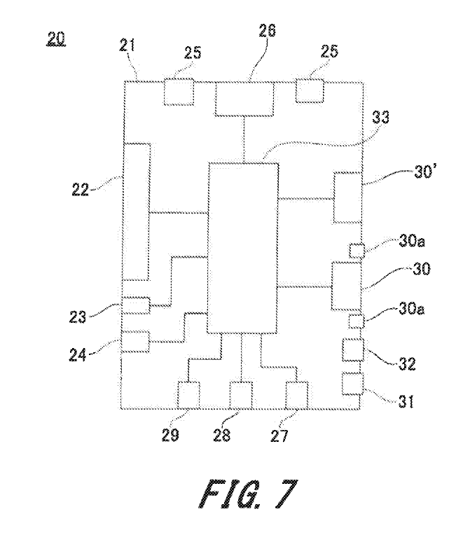

FIG. 7 is a functional block diagram of the controller 20 according to the embodiment of the present invention. As shown in FIG. 7, in addition to the aforesaid elements, the controller 20 also includes a control section 33 housed in the operation casing 21. As a circle mounted on an IC chip, the control section 33 has the following configuration.

### [Control Section 33]

The control section 33 is connected to the display panel 22, the function keys 23, the speaker 24, the recording medium inserting portion 26, the power button 27, the imaging operating section 28, the display operating section 29, and the connection terminals 30, 30′. The control section 33 controls the signal to be outputted to the display panel 22 and the speaker 24 in accordance with the operations of the function keys 23, the power button 27, the imaging operating section 28 and the display operating section 29. Further, the control section 33 controls the signal to be outputted to the outside through the connection terminals 30, 30′, and controls the storage and readout of the data between itself and the recording medium inserted into the recording medium inserting portion 26.

The control section 33 is a computer constituted of a CPU, a ROM, and a RAM, wherein the CPU executes a program recorded in the ROM or RAM to thereby perform the aforesaid control.

Incidentally, in addition to the control section 33, a battery is also housed in the operation casing 21 of the controller 20; electrical power is supplied from the battery to the imaging terminal device 10 through the connection terminals 30, 30′.

### <<Coupling Portion>>

The coupling portion between the imaging terminal device and the controller 20 is configured by the imaging-side coupling member 16 provided on the imaging casing 11 of the imaging terminal device 10 and the controller-side coupling member 25 provided on the operation casing 21 of the controller 20. The coupling portion is configured so that the imaging-side coupling member 16 and the controller-side coupling member 25 can be coupled to each other in a manner in which the two coupling members can be detached from each other and, in a state where the two coupling members are coupled to each other, the two coupling members can be rotated relative to each other as well as being supported by each other. The configuration of the imaging-side coupling member 16 and the configuration of the controller-side coupling member 25 are not particularly limited as long as the aforesaid function can be performed by the coupling portion.

### <<Connection Cable 40>>

The configuration of the connection cable 40 will be described below. As shown in FIG. 3 and FIG. 5, the connection cable 40 is provided with an imaging-side terminal 41 and a controller-side terminal 42 on both ends thereof. The imaging-side terminal 41 and controller-side terminal 42 are each a USB plug (which may be a micro USB plug), for example. Further, the connection cable 40 is provided with two screw holes 41a at two positions with the imaging-side terminal 41 interposed therebetween, so that the connection cable 40 is fastened to the imaging terminal device 10 by screwing two screws 41b into the two screw holes 41a. Further, the connection cable 40 is provided with two screw holes 42a at two positions with the controller-side terminal 42 interposed therebetween, so that the connection cable 40 is fastened to the controller 20 by screwing two screws 42b into the two screw holes 42a.

Incidentally, the imaging-side terminal 41 and the controller-side terminal 42 are indispensable components necessarily to be provided on both ends of the connection cable 40; however the screw holes 41a, 42a may be provided according to necessity, instead of being indispensable elements.

### <<First Example of Use Configuration of Imaging Device 1>>

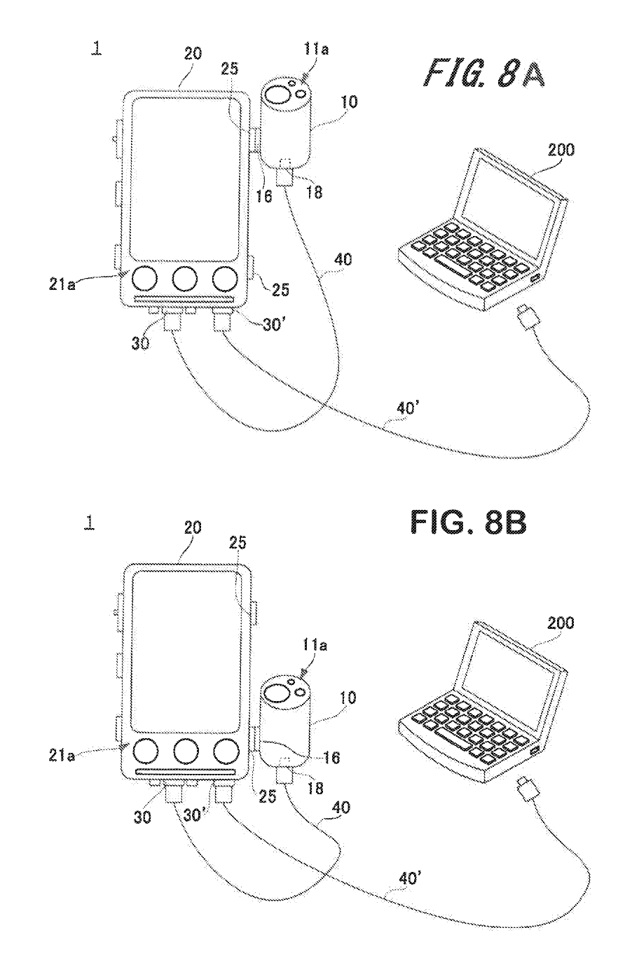

FIG. 8A and FIG. 8B are views showing a first example of the use configuration of the imaging device 1 according to the embodiment of the present invention. As shown in FIG. 8A and FIG. 8B, the imaging device 1 is used in a state where the imaging terminal device 10 is coupled to either one of the two controller-side coupling members 25 of the controller 20. At this time, the coupling position where the imaging terminal device 10 is coupled to the controller 20 is arbitrarily selected between the position shown in FIG. 8A and the position shown in FIG. 8B. Although not shown in the drawings, in the imaging device 1, the imaging terminal device 10 and the controller 20 may each be used alone as a handheld device of the photographer by releasing the coupling state between the imaging terminal device 10 and the controller 20 to thereby separate the imaging terminal device 10 and the controller 20 from each other.

Further, the imaging device 1 is used in a state where the imaging terminal device 10 and the controller 20 are connected to each other by the connection cable 40. With such a configuration, it is possible for the photographer to operate the controller 20 to take images with the imaging terminal device 10 in a state where the imaging surface 11a of the imaging terminal device 10 faces the subject-to-be-imaged, while the controller 20 is oriented in a direction in which the display surface 21a thereof can be easily viewed by the photographer.

Further, in the imaging device 1, another connection cable 40′ may be used to connect an operation terminal device 200 (such as a personal computer or the like) to the connection terminal 30′ of the controller 20, so that the imaging terminal device 10 can be operated by the operation terminal device 200, and imaging information obtained by the imaging terminal device 10 can be taken into the operation terminal device 200 in real time.

Further, although not shown in the drawings, the imaging device 1 may be fixed to a tripod by using the tripod socket of the imaging terminal device 10 or the tripod socket of the controller 20.

As described above, with the imaging device 1, the photographer can change the coupling position of the imaging terminal device 10 and the controller 20 between two places. Thus, even if the imaging surface 11a of the imaging terminal device 10 is positioned at any angle with respect to the subject-to-be-photographed, it is possible to operate the controller 20 with excellent operability while maintaining excellent visibility of the display surface 21a of the controller 20, without worrying about the reflection of external light, for example.

### <<Second Example of Use Configuration of Imaging Device 1>>

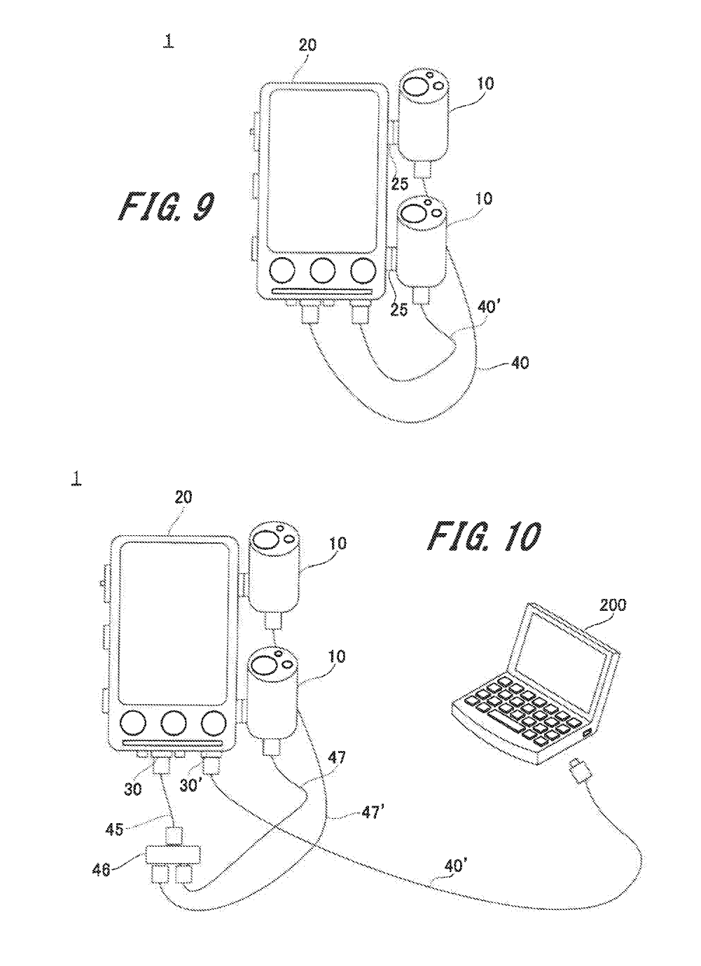

FIG. 9 is a view showing a second example of the use configuration of the imaging device 1 according to the embodiment of the present invention. As shown in FIG. 9, the imaging device 1 is used in a state where two imaging terminal devices 10 are coupled to the two controller-side coupling members 25 of the controller 20 respectively. In such a case, similar to the first example, the imaging device 1 may be fixed to a tripod by using the tripod socket of the imaging terminal device 10 or the tripod socket of the controller 20.

Thus, the imaging device 1 can be used to take images in a state in which two imaging terminal devices 10 are coupled to one controller 20, so that it is possible to take stereo images with the two imaging terminal devices 10.

### <<Third Example of Use Configuration of Imaging Device 1>>

FIG. 10 is a view showing a third example of the use configuration of the imaging device 1 according to the embodiment of the present invention. As shown in FIG. 10, compared with the second example, in the third example, the imaging device 1 is used in a state where an operation terminal device 200 (such as a personal computer or the like) is further connected to the controller 20. In such a case, for example, a USB hub 46 is connected to the connection terminal 30 of the controller 20 using a connection cable 45, and two imaging terminal devices 10 are connected to the USB hub 46 using two distributing cables 47, 47′. On the other hand, the operation terminal device 200 may be connected to the connection terminal 30′ of the controller 20 using another connection cable 40′.

With such a configuration, the two imaging terminal devices 10 can be operated by the operation terminal device 200, and imaging information obtained by the two imaging terminal devices 10 can be taken into the operation terminal device 200 in real time.

The aforesaid embodiment of the present invention is described based on an example in which the imaging terminal device 10 is to be detachably coupled to two places of the controller 20; however, the imaging terminal device 10 may also be detachably coupled to a plurality of places, instead of being limited to two places, of the controller 20. Further, the present invention also includes a configuration in which the controller 20 is to be detachably coupled to a plurality of places of the imaging terminal device 10. In such a case, the imaging-side connection member 16 may be provided at a plurality of places of the imaging casing 11 of the imaging terminal device 10. With such a configuration, the operability of various operation sections of the controller 20 and the operation section 15 of the imaging terminal device 10 can be improved by changing the coupling position of the controller 20 with respect to the imaging terminal device 10, depending on the arrangement state of these operation sections. Further, with such a configuration, it becomes possible to maintain excellent visibility of the image displayed on the display surface 21a of the controller 20 without being affected by the coupling angle of the imaging terminal device 10.

1. An imaging device comprising:
an imaging terminal device having an imaging member;
a controller having an operation section that operates the imaging terminal device; and
a coupling portion that couples the imaging terminal device and the controller to each other in a manner in which the imaging terminal device and the controller can be detached from each other and rotated relative to each other,
wherein the coupling portion is configured by an imaging-side coupling member provided in the imaging terminal device and a controller-side coupling member provided in the controller, the controller-side coupling member being fitted into the imaging-side coupling member, and
wherein at least one of the imaging-side coupling member and the controller-side coupling member is provided at a plurality of places.

2. The imaging device according to claim 1, further comprising:
a connection cable that connects the imaging terminal device and the controller to each other,
wherein the imaging terminal device and the controller are each provided with a connection terminal to which the connection cable is to be connected.

3. The imaging device according to claim 1, wherein the controller is provided with a plurality of the controller-side connection members.

4. The imaging device according to claim 3, wherein the controller is provided with a plurality of connection terminals to which the imaging terminal device is to be electrically connected.

5. The imaging device according to claim 1, wherein the imaging terminal device is provided with an infrared camera as the imaging member.

6. The imaging device according to claim 5, wherein the imaging terminal device is provided with a visible camera as the imaging member.

7. The imaging device according to claim 1,
wherein the controller has a display surface, and
wherein the coupling portion couples the imaging terminal device and the controller to each other on a surface substantially perpendicular to the display surface of the controller.

8. The imaging device according to claim 7, wherein the coupling portion couples the controller and the imaging terminal device to each other in a manner in which the controller and the imaging terminal device can be rotated relative to each other in parallel with a surface substantially perpendicular to the display surface of the controller.

9. The imaging device according to claim 1, wherein the imaging terminal device has an imaging surface which faces in a direction perpendicular to a rotation axis around which the imaging terminal device and the controller rotate relative to each other.

10. The imaging device according to claim 1, wherein the imaging terminal device has an operation section that operates the imaging member.
